(19) United States
(12) Patent Application Publication
(10) Pub. No.: US 2023/0060014 A1
(43) Pub. Date: Feb. 23, 2023

(54) BATTERY CARRYING TRAY PROVIDED WITH PROTECTING STRUCTURE

(71) Applicant: HANIL HIGHTECH CO., LTD., Hwaseong-si (KR)

(72) Inventors: Jung Yi HWANG, Gumi-si (KR); Young Hoon KIM, Osan-si (KR)

(73) Assignee: HANIL HIGHTECH CO., LTD., Hwaseong-si (KR)

(21) Appl. No.: 17/536,767

(22) Filed: Nov. 29, 2021

(30) Foreign Application Priority Data
Aug. 19, 2021 (KR) 10-2021-0109581

(51) Int. Cl. H01M 50/209; H01M 50/536

(52) U.S. Cl. CPC H01M 50/209; H01M 50/536

(57) ABSTRACT

A battery carrying tray includes: a box-shaped outer peripheral frame, and a pair of slot-shaped mounting parts symmetrically mounted in the outer peripheral frame. The mounting part includes: an insert having a plurality of first slots into which lateral ends of cells of batteries are inserted, and a plurality of second slots into which tab welded portions of the batteries are inserted and supported; and an insert base having seating portions on which lower ends of the cells of the batteries are seated. The insert includes: a plurality of pins disposed in parallel at predetermined intervals to define the first slots therebetween; wing flanges respectively formed at outer ends of the pins to define the second slots between the wing flanges formed on the adjacent pins; and a horizontal base portion on which the plurality of pins is supported.

### CROSS-REFERENCE TO RELATED APPLICATION

This application claims priority to Korean Patent Application No. 10-2021-0109581 (filed on Aug. 19, 2021), which is hereby incorporated by reference in its entirety.

### BACKGROUND

The present disclosure relates to a battery carrying tray used to convey a product between processes in a production line or deliver the product, and more particularly, to a battery carrying tray capable of protecting a weak portion of a battery accommodated thereon. In particular, a battery to which the tray is applied means a pouch cell secondary battery.

Recently, pouch cell secondary batteries are widely used for various products including IT products such as smartphones, notebook computers, tablet PCs, and auxiliary batteries, hybrid electric vehicles, or energy storage systems (ESSs). The pouch cell secondary battery generates electricity by moving lithium ions between a positive electrode and a negative electrode.

FIG. 1 is a structural view illustrating a typical pouch cell secondary battery 10. The pouch cell secondary battery 10 typically includes a cell 11 configured to store electric power, a pouch 12 configured to surround the cell, and electrode leads 13 used to charge or discharge the cell. A thickness of the cell 11 is as relatively thick as 8 to 15 t, and the electrode lead 13 is welded to a peripheral edge of the cell 11 and forms a tab welded portion 14. The tab welded portion 14 has a greater thickness than the pouch 12 at the periphery of the tab welded portion 14. Typically, the pouch cell secondary batteries (hereinafter, simply referred to as a ‘battery’) 10 may be classified into a bidirectional battery illustrated in FIG. 1 and having the charging and discharging leads formed in two opposite directions, and a unidirectional battery having a lead formed in one direction. In addition, the batteries have various shapes in accordance with product specifications such as thicknesses, widths, and lead heights. The battery is generally manufactured to be thin so that the plurality of batteries may be electrically connected and used in a limited space.

In the related art, in the production line for the battery, a battery carrying tray is used as a means for safely accommodating and carrying the batteries at the time of conveying the batteries between processes or delivering the batteries as finished products. The battery carrying tray may accommodate a large number of thin batteries in an upright state. In general, the battery carrying tray includes an outer peripheral frame, and a pair of slot-shaped mounting parts symmetrically mounted in the outer peripheral frame. The plurality of batteries is disposed and accommodated in parallel between the pair of slot-shaped mounting parts. In this case, in a state in which the battery is accommodated in the tray, parts of a main body of the cell 11, which constitute two opposite left and right ends of the battery, the tab welded portions 14, a part of a lateral portion of the pouch 12, and a part of a lower portion of the pouch 12 are generally inserted and supported in a slot or the like provided in the mounting part.

In the battery carrying tray having the slot-shaped mounting parts, particular portions of the battery inserted into the slot of the tray are frequently damaged because of contact or vibration occurring during the process, which causes product defects. Representatively, the tab welded portion 14 is one of the portions inserted and supported in the slot of the tray, but the tab welded portion 14 is structurally weak because the tab welded portion 14 is a welded portion intrinsically thicker than the pouch at the periphery thereof. Further, there is an increasing likelihood that the tab welded portion 14 is damaged because of the impact caused by contact with the tray component element by vibration swaying during the process of manufacturing the battery. In addition, the main body of the cell 11 is the thickest and relatively hard portion in the battery 10 but vulnerable to impact. For this reason, the main body of the cell 11 is damaged because of vibration swaying in a state in which a lateral end of the main body of the cell 11 is accommodated in the slot, which directly causes a product defect. In addition, a lower corner portion of the cell 11 is particularly vulnerable to the contact because the lower corner portion of the cell 11 has a right-angled shape. There is an increasing likelihood that the lower corner portion of the cell 11 is damaged by repeated friction during the process of attaching or detaching the battery to/from the tray or there is also an increasing likelihood that the lower corner portion of the cell 11 is damaged as a contact pressure between the corner portion of the cell 11 and the tray component element increases in a process in which the cell 11 expands during the process of manufacturing the battery.

Meanwhile, Korean Patent Nos. 10-1839120 and 10-2094854 and Korean Patent Application Laid-Open No. 10-2021-0007271 filed in the name of the present applicant disclose various examples of the battery carrying tray having the slot-shaped mounting part. However, the patent documents only disclose that the slot-shaped mounting part may be assembled to an outer peripheral frame and applied to mount and carry batteries various specifications without separately manufacturing or replacing tray component elements. However, design capable of protecting particular portions of the battery 10, such as the lower corner portion of the cell 11, the tab welded portion 14, and the main body of the cell 11, which are particularly vulnerable to contact or vibration, is still insufficient, and thus the improvement thereof is required.

### DOCUMENTS OF RELATED ART

### Patent Documents

(Patent Document 1) Korean Patent No. 10-1839120

(Patent Document 2) Korean Patent No. 10-2094854

(Patent Document 3) Korean Patent Laid-Open No. 10-2021-0007271

### SUMMARY

An object to be achieved by the present disclosure is to provide a battery carrying tray provided with a protecting structure capable of preventing important parts, such as a tab welded portion, a main body of a cell, and a lower corner portion of the cell, which directly affect battery performance, from being damaged because of contact or vibration occurring during a process in a state in which a battery is accommodated in a tray.

The subject matters of the present disclosure related to the technical solutions identical to the features disclosed in claims are as follows.

According to an aspect of the present disclosure, there is provided a battery carrying tray including: a box-shaped outer peripheral frame; and a pair of slot-shaped mounting parts symmetrically mounted in the outer peripheral frame, in which when an inner side of the battery carrying tray is an inner side and an outer side of the battery carrying tray is an outer side, the mounting part includes: an insert having a plurality of first slots into which lateral ends of cells of batteries are inserted, and a plurality of second slots into which tab welded portions of the batteries are inserted and supported; and an insert base having seating portions on which lower ends of the cells of the batteries are seated, in which the insert includes: a plurality of pins disposed in parallel at predetermined intervals to define the first slots therebetween; wing flanges respectively formed at outer ends of the pins to define the second slots between the wing flanges formed on the adjacent pins; and a horizontal base portion on which the plurality of pins is supported, and in which upper and lower portions of a lateral end of the wing flange are convex toward an inner space of the second slot, and a middle portion of the wing flange is concave and has a wavy shape as a whole.

The pin may have a convex portion formed toward an inner space of the first slot.

The convex portion may have a gradient that decreases toward the inner side.

An entrance distance of an outer lateral end of the seating portion to an inner end of the pin of the insert may be restricted, an upper surface of the seating portion may be positioned higher than an upper surface of the horizontal base portion, and a lower end of the wing flange may be bent toward the inner side.

An inclined portion inclined toward the outer side may be provided at an inner lower end of the pin.

The insert and the insert base may be assembled in a snap-fit manner.

According to the battery carrying tray according to the present disclosure, the insert and the insert base, which constitute the mounting part for the battery, are structured to be assembled, and the respective shape elements related to the contact parts of the battery are controlled. Therefore, basically, the movements of the tab welded portion and the main body of the cell in the accommodated state are minimized, the contact is avoided, the locally applied stress is minimized, or optionally, the direct contact with the cell corner portion is avoided. Therefore, it is possible to effectively prevent the important parts, which directly affect the performance of the battery, from being damaged by contact or vibration occurring during the process and reduce a defect of the battery.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a structural view of a general pouch cell secondary battery;

FIG. 2 is a perspective view of a battery carrying tray according to an embodiment of the present disclosure;

FIG. 3 is an exploded perspective view of the battery carrying tray according to the embodiment of the present disclosure;

FIG. 4 is a view illustrating an insert that constitutes a slot-shaped mounting part according to the embodiment of the present disclosure;

FIG. 5 is a view illustrating an insert base that constitutes the slot-shaped mounting part according to the embodiment of the present disclosure;

FIG. 6 is a view illustrating a method of assembling the insert and the insert base;

FIG. 7 is a view illustrating a state in which a battery is accommodated in the slot-shaped mounting part according to the embodiment of the present disclosure;

FIG. 8 is a view illustrating a shape of an insert according to another embodiment of the present disclosure and a state in which a battery is accommodated in a slot-shaped mounting part including the insert; and

FIG. 9 is a view illustrating a state in which a battery is accommodated in a slot-shaped mounting part according to still another embodiment of the present disclosure.

### DETAILED DESCRIPTION

Hereinafter, the present disclosure will be described in detail with reference to the embodiments. In addition, terms or words used in the specification and the claims should not be interpreted as being limited to a general or dictionary meaning and should be interpreted as a meaning and a concept which conform to the technical spirit of the present disclosure based on a principle that an inventor can appropriately define a concept of a term in order to describe his/her own invention by the best method. Therefore, the configurations of the exemplary embodiments disclosed in the present specification are just the best preferred exemplary embodiments of the present disclosure and do not represent all the technical spirit of the present disclosure. Accordingly, it should be appreciated that various equivalents and modified examples capable of substituting the exemplary embodiments may be made at the time of filing the present application. Meanwhile, the same or similar constituent elements and the equivalents thereof will be designated by the same or similar reference numerals. Further, throughout the specification of the present application, unless explicitly described to the contrary, the word “comprise” or “include” and variations, such as “comprises”, “comprising”, “includes” or “including”, will be understood to imply the inclusion of stated constituent elements, not the exclusion of any other constituent elements.

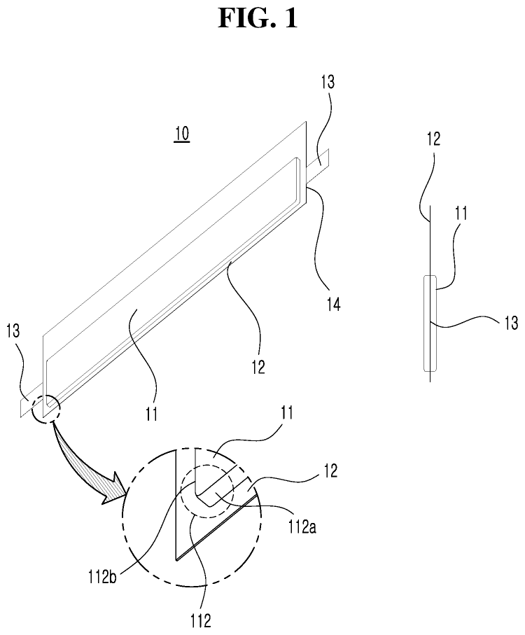

The present disclosure relates to a battery carrying tray 30 provided with a protecting structure capable of preventing important parts, which directly affect performance of a battery 10, from being damaged because of contact or vibration occurring during a process in a state in which the battery 10 is accommodated in a tray 30. A structure of the battery 10 accommodated in the battery carrying tray 30 according to the present disclosure is assumed as the structure of the battery illustrated in FIG. 1.

In this case, the important parts, which directly affect the performance of the battery 10, are parts inserted and supported in slots of the tray 30. The important parts basically include a tab welded portion 14 and selectively include a cell 11 and a lower corner portion of the cell 11 (hereinafter, simply referred to as a ‘cell corner portion 11’). Therefore, the protecting structure of the battery carrying tray 30 according to the present disclosure is basically associated with the tab welded portion 14 and selectively associated with the main body of the cell 11 and the cell corner portion 112.

Hereinafter, the entire structure of the battery carrying tray 30 according to the present disclosure will be schematically described and then the protecting structure for protecting main parts of the battery 10 will be described sequentially. In the following description, for convenience, an inner side of the tray 30 will be described as an ‘inner side’, and an outer side of the tray 30 will be described as an ‘outer side’.

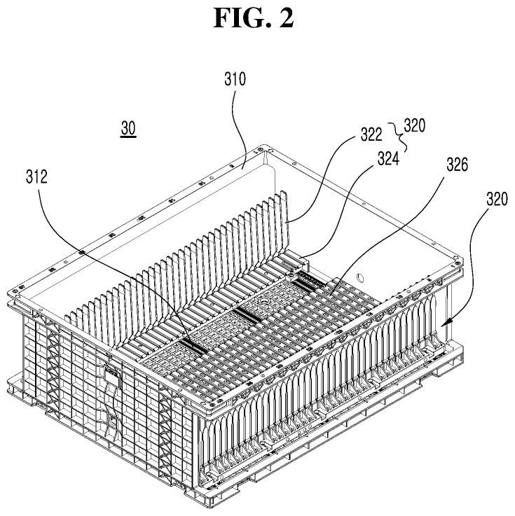

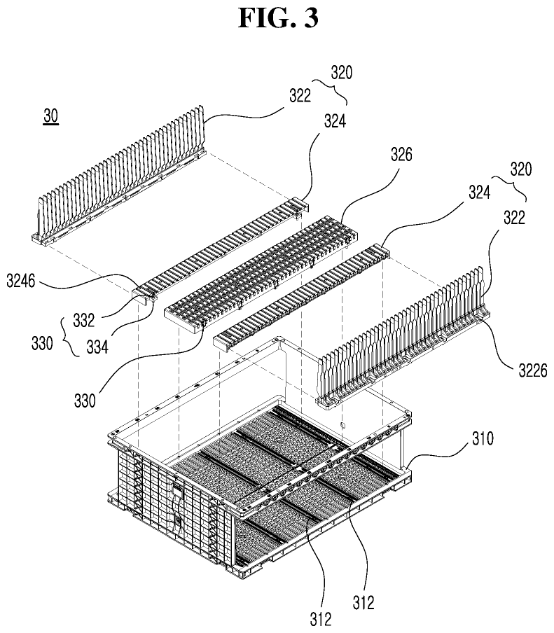

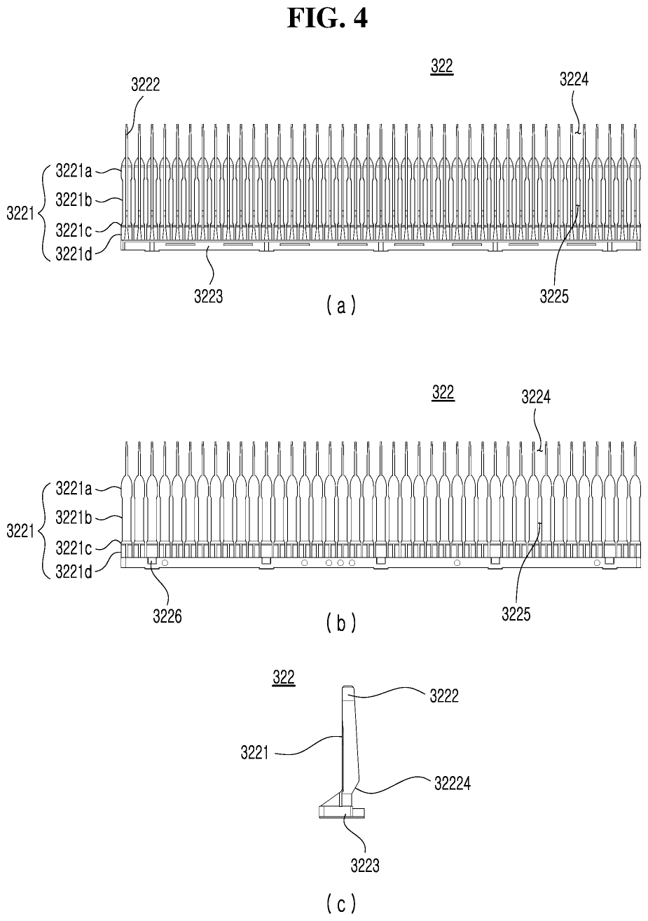

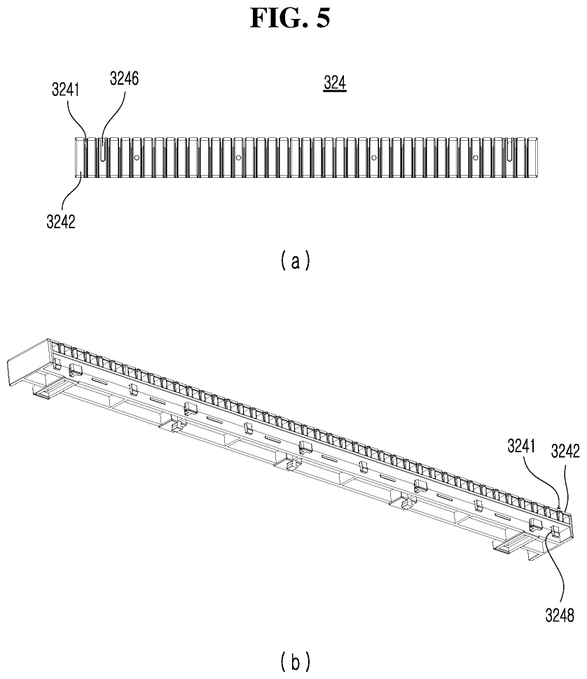

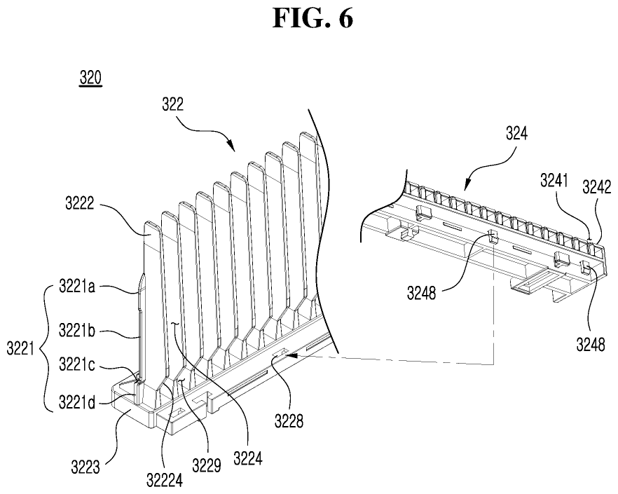

FIGS. 2 and 3 are a perspective view and an exploded perspective view of the battery carrying tray 30 (hereinafter, simply referred to as the ‘tray 30’) according to the embodiment of the present disclosure. FIG. 4 is a view illustrating an insert 322 that constitutes a slot-shaped mounting part 320 according to the embodiment of the present disclosure, in which FIG. 4A is a front view illustrating the tray 30 from the inside, FIG. 4B is a rear view illustrating the tray 30 from the outside, and FIG. 4C is a side view. FIG. 5 is a view illustrating an insert base 324 that constitutes the slot-shaped mounting part 320 according to the embodiment of the present disclosure, in which FIG. 5A is a top plan view, and FIG. 5B is a bottom perspective view. FIG. 6 is a view illustrating a method of assembling the insert 322 and the insert base 324.

Referring to FIGS. 2 and 3, the tray 30 includes a box-shaped outer peripheral frame 310, and a pair of slot-shaped mounting parts 320 symmetrically mounted in the outer peripheral frame 310. The tray 30 may further include a center base 326 provided between the pair of mounting parts 320 in order to prevent a middle portion of the battery 10 having a large size from being damaged by bending stress caused by a weight of the battery 10. The pair of slot-shaped mounting parts 320 is coupled to a bottom surface of the outer peripheral frame 310 by fastening members 330 so as to be slidable along long grooves 312.

The outer peripheral frame 310 is made of hard plastic resin and spatially separates a region for accommodating the battery 10 in the slot-shaped mounting part 320 from the outside. The outer peripheral frame 310 is opened at an upper side thereof so that the battery 10 may be unloaded from and mounted on the slot-shaped mounting part 320. Meanwhile, the outer peripheral frame 310 having sidewalls, at least one of which is opened so that various component elements accommodated in the outer peripheral frame 310 are assembled, disassembled, and adjusted in specifications.

Referring to FIGS. 4 to 6, the pair of slot-shaped mounting parts 320 each include the insert 322 and the insert base 324, and the insert 322 and the insert base 324 are assembled in the embodiment. The assemblies 320 each including the insert 322 and the insert base 324 are symmetrically provided at two opposite sides in the outer peripheral frame 310 and fixed by the fastening members 330, and the assemblies 320 may slide along the long grooves 312 provided in the bottom surface depending on a size of the battery 10 to be accommodated in a state in which the assemblies 320 are disposed at a predetermined interval from each other.

The insert 322 illustrated in FIG. 4 includes a plurality of pins 3222, a plurality of wing flanges 3221, and a horizontal base portion 3223. The horizontal base portion 3223 serves as a support portion for constituting the insert 322 and is fixed to the outer peripheral frame 310 by the fastening member 330. The horizontal base portion 3223 has a plurality of fastening holes 3226 formed at positions to which the fastening members 330 are coupled. The fastening member 330 is coupled to the long groove 312 through the fastening hole 3226. The plurality of pins 3222 is provided on an upper surface of the horizontal base portion 3223 and disposed in parallel at predetermined intervals. The pin 3222 is a shape element extending upward. A space between the adjacent pins 3222 serves as a first slot 3224 into which a lateral end of the cell 11 of the battery 10 is inserted and supported. The wing flange 3221 is a shape element extending from one end, i.e., an outer end of the pin 3222 in left and right symmetric directions. A space between the adjacent wing flanges 3221 serves as a second slot 3225 into which the tab welded portion 14 of the battery 10 is inserted. The main body of the cell 11 is accommodated in the first slot 3224. An edge portion of the main body of the cell 11 is in contact with and supported on sidewalls of the pins 3222 and inner walls of the wing flanges 3221.

The insert base 324 illustrated in FIG. 5 has seating portions 3242 on which a lower end of the cell 11 of the battery 10 illustrated in FIG. 1 is seated. The seating portions 3242 of the insert base 324 are separated at predetermined intervals by slits 3241, and the interval at which the seating portions 3242 are separated by the slit 3241 is equal to the interval at which the pins 3222 of the insert 322 are disposed. A part of a portion of the pouch 12 at the lower end of the battery 10 is inserted and supported in the slit 3241. The slit 3241 is aligned with the first slot 3224 and the second slot 3225 side by side. Meanwhile, some of the seating portions 3242 of the insert base 324 have fastening grooves 3246 corresponding to positions to which the fastening members 330 are coupled.

Referring to FIG. 6, the present disclosure is characterized in that the inserts 322 and the insert bases 324, which constitute the pair of mounting parts 320, are assembled. Snap grooves 3228 are provided in an inner portion of the insert 322, and snap protrusions 3248 are provided on an outer portion of the insert base 324, such that the insert 322 and the insert base 324 are assembled in a snap-fit manner. Since the slot-shaped mounting part 320 is implemented by assembling the insert 322 and the insert base 324, it is possible to effectively solve the problem in the related art caused by a limitation in the injection-molding manufacturing process, such as a limitation in designing cores of upper and lower molds, in a case in which a slot-shaped mounting part is implemented as a single injection-molded product.

For example, in the case in which the insert 322 and the insert base 324 are designed to be assembled and manufactured as independent component elements, it is possible to freely design the shape elements such as the pins 3222 and the wing flanges 3221 of the insert 322, which constitute the first slots 3224 and the second slots 3225, or the seating portions 3242 of the insert base 324 in order to prevent the cell corner portion 112, the tab welded portion 14, and the main body of the cell 11, which are the important parts of the accommodated battery 10, from being damaged. Therefore, as described below, it is possible to more easily avoid contact with the cell corner portion 112 by naturally forming cavities 3229 at lower sides of the first slots 3224 only by means of an assembly level difference in a direction in which the insert 322 and the insert base 324 are assembled without separately designing the shape elements, i.e., an assembly level difference occurring when bottom surfaces of the seating portions 3242 of the insert base 324 are assembled to an upper surface of the horizontal base portion 3223 of the insert 322.

Referring to FIG. 3, the fastening members 330 include bolts 332 and nuts 334 assembled at upper and lower sides of the long grooves 312. The bolts 332 are applied from above the tray 30 and fix the pair of mounting parts 320 and insert base 324 to the outer peripheral frame 310.

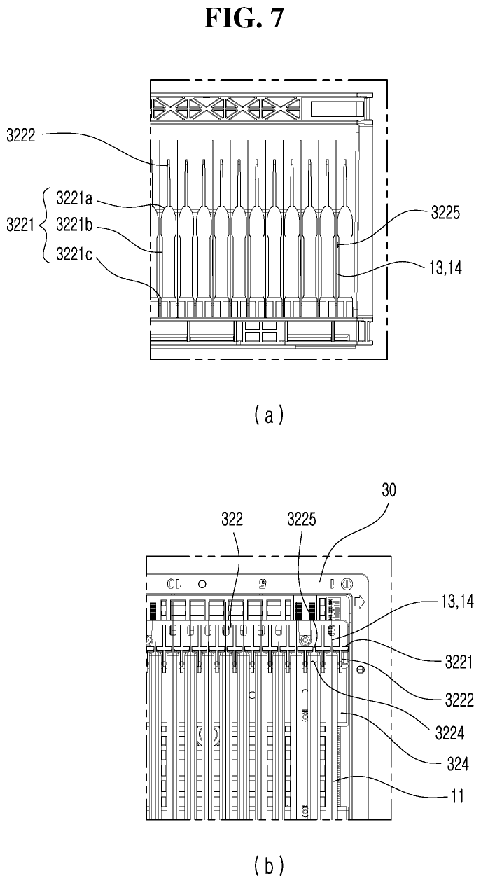

FIG. 7 is another view illustrating a state in which the battery 10 is accommodated in the slot-shaped mounting part 320 according to the embodiment of the present disclosure, in which FIG. 7A is a front view illustrating the tray 30 from the outside, and FIG. 7B is a top plan view.

Referring to FIG. 7, the feature of the present disclosure is the protecting structure for protecting the weak tab welded portion 14. The protecting structure is associated with another improvement of the shape element of the slot-shaped mounting part 320. The tab welded portion 14 of the battery 10 is one of the parts inserted and supported in the slots of the tray 30. In the present disclosure, the tab welded portion 14 is assumed as being inserted and supported in the second slot 3225 of the slot-shaped mounting part 320.

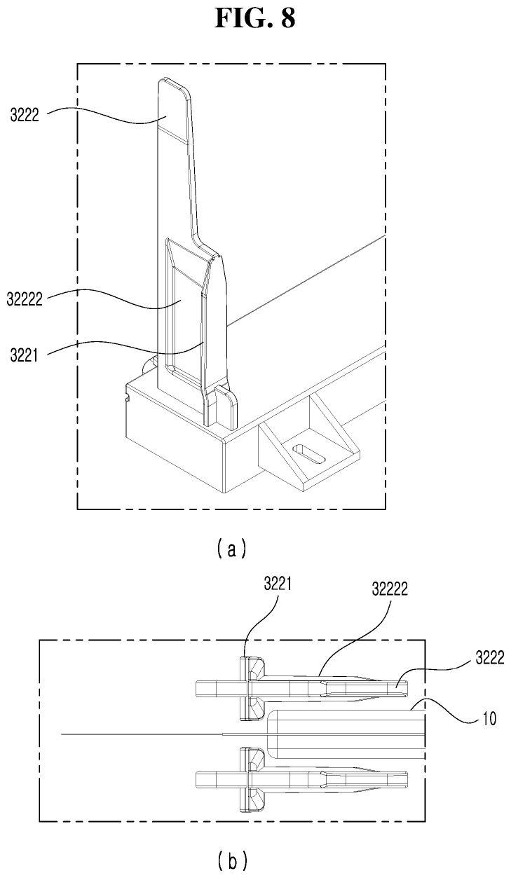

In this case, to protect the tab welded portion 14, a shape of the second slot 3225 is approximately coincident with a cross-sectional shape of the tab welded portion 14, and a predetermined interval is formed between the surface of the wing flange 3221 and the tab welded portion 14, thereby preventing the tab welded portion 14 from being in direct contact with the surface of the wing flange 3221. That is, to match the shape of the second slot 3225 with the cross-sectional shape of the tab welded portion 14, an upper portion 3221a and a lower portion 3221c at the lateral end of the wing flange 3221 are convex toward an inner space of the second slot 3225, and a middle portion 3221b of the wing flange 3221 is relatively concave and has a wavy shape as a whole. Therefore, the tab welded portion 14 in the accommodated state is minimally affected by external vibration occurring during the process, local contact stress applied to the periphery of the tab welded portion 14 is minimized, and the accommodated tab welded portion 14 is prevented from easily separating upward from the second slot 3225. FIG. 8 is a view illustrating (a) a shape of an insert 322 according to another embodiment present disclosure and (b) a state in which the battery 10 is accommodated in a slot-shaped mounting part 320 including the insert 322. For reference, only the single pin 3222 of the insert 322 is illustrated in FIG. 8A, and the insert base 324 constituting the slot-shaped mounting part 320 is omitted from FIG. 8B.

Referring to FIG. 8, another feature of the present disclosure is the protecting structure for protecting the main body of the cell 11. Like the above-mentioned description, the protecting structure is associated with still another improvement of the shape element of the slot-shaped mounting part 320. The main body of the cell 11 is the thickest and relatively hard portion in the battery 10 but particularly vulnerable to impact. Therefore, in the present disclosure, the slot-shaped mounting part 320 is assumed as being inserted and supported in the first slot 3224. That is, it is assumed that the lateral end of the main body of the cell 11 is in contact with and supported on the inner surface of the wing flange 3221 to prevent the outward separation, the two opposite surfaces of the lateral end of the main body of the cell 11 are in contact with and supported on the inner wall of the pin 3222 to prevent the leftward and rightward movements, and the bottom surface of the main body of the cell 11 is placed on the seating portion 3242.

In this case, to protect the main body of the cell 11, a width of the first slot 3224 (a width between the pins 3222) is approximately coincident with a thickness of the main body of the cell 11, such that the leftward and rightward movements of the main body of the cell 11 are minimized, and the contact areas at the two opposite sides of the main body of the cell 11 are minimized. That is, the pin 3222 has a convex portion 32222 formed toward the inner space of the first slot 3224. The convex portion 32222 adjusts a gap of the first slot 3224 in which the main body of the cell 11 is accommodated, which makes it possible to minimize the leftward and rightward movements of the main body of the cell 11 in the accommodated state and reduce the contact area of the surface of the main body of the cell 11.

In addition, optionally, the convex portion 32222 may have a gradient that decreases toward the inner side. Therefore, even when the main body of the cell 11 moves in the first slot 3224, it is possible to prevent the main body of the cell 11 from being damaged by being pressed by a sharp edge of the convex portion 32222.

The configuration related to the convex portion 32222 for protecting the main body of the cell 11 is also associated with the protection of the tab welded portion 14. That is, the movement of the main body of the cell 11 in the first slot 3224 is minimized by the convex portion 32222, the movement of the tab welded portion 14 in the second slot 3225 is inhibited, and the contact between the tab welded portion 14 and the wing flange 3221 is inhibited. Therefore, it is possible to reduce a likelihood that the main body of the cell 11 is damaged.

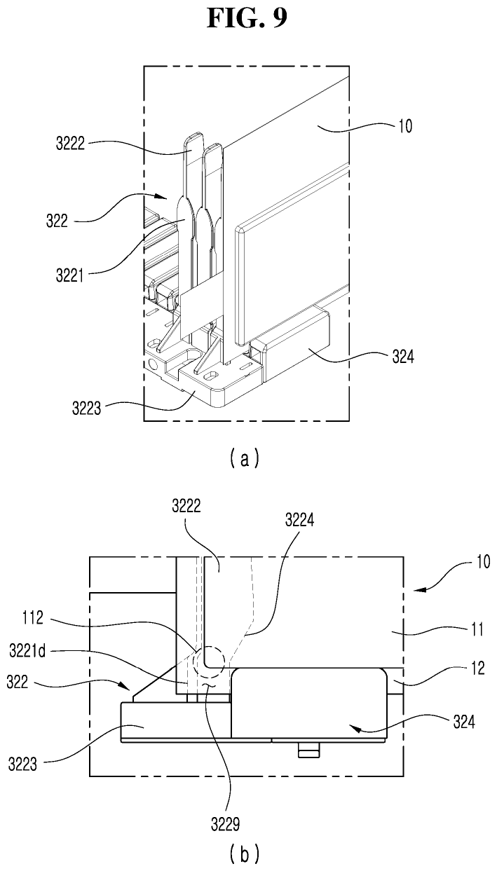

FIG. 9 is a view illustrating a state in which the battery 10 is accommodated in the slot-shaped mounting part 320 according to still another embodiment of the present disclosure, in which FIG. 9A is a perspective view, and FIG. 9B is a side view. To clearly illustrates a state in which the battery 10 in the accommodated state is in contact with the insert 322 and the insert base 324 that constitute the slot-shaped mounting part 320, some of the pin 3222 located at the front side in the FIG. 9 are omitted or transparently illustrated.

Referring to FIG. 9, one of the features of the present disclosure is the protecting structure for protecting the weak cell corner portion 112. The protecting structure is associated with the improvement of the shape element of the slot-shaped mounting part 320. In this case, the protecting structure for protecting the cell corner portion 112 may include protecting structures for protecting a bottom portion 112a and a lateral portion 112b of the cell corner portion 112. The present disclosure includes at least one of the protecting structures.

Specifically, to protect the bottom portion 112a of the cell corner portion 112, an entrance distance of the seating portion 3242 of the insert base 324 to an inner end of the pin 3222 of the insert 322 may be restricted, and an upper surface of the seating portion 3242 may be positioned higher than an upper surface of the horizontal base portion 3223. Therefore, the cavity 3229 is formed at the lower side of the first slot 3224. The cavity 3229 is defined in four directions by the sidewalls of the pins 3222, the inner walls of the wing flanges 3221, and an outer wall of the seating portion 3242. A bottom portion of the cavity 3229 is defined by the horizontal base portion 3223, and the cavity 3229 is opened at an upper side thereof. The bottom portion 112a of the accommodated cell corner portion 112 is exposed to the cavity 3229, which avoids direct contact between the component element of the tray 30 and the bottom portion of the cell corner portion 112, thereby preventing contact damage to the bottom portion 112a of the cell corner portion 112 during the process.

Meanwhile, in the case in which the entrance distance of the seating portion 3242 of the insert base 324 to the inner end of the pin 3222 of the insert 322 is restricted to protect the cell corner portion 112, a surface element of the seating portion 3242 with respect to a bottom surface of the main body of the cell 11 accommodated in the first slot 3224 decreases, which may degrade accommodation stability. Therefore, in the present disclosure, an inclined portion 32224 inclined toward the outer side may be provided at an inner lower end of the pin 3222 to ensure the surface element of the seating portion 3242 in the first slot 3224 without impairing the purpose of the restriction in entrance distance. Therefore, the contact with the bottom portion 112a of the cell corner portion 112 is avoided, and the bottom surface of the main body of the cell 11 is seated on the seating portion 3242 with a sufficient seating area, which ensures accommodation stability.

In addition, a lower end 3221d of the wing flange 3221 is bent inward to protect the lateral portion 112b of the cell corner portion 112. Therefore, the direct contact between the wing flange 3221 and the lateral portion 112b of the accommodated cell corner portion 112 is avoided, it is possible to prevent the contact damage to the lateral portion of the cell corner portion 112 during the process. That is, the lateral portion 112b of the main body of the cell 11 is mostly in close contact with the inner portion of the wing flange 3221 in the state in which the lateral portion 112b of the main body of the cell 11 is accommodated in the first slot 3224, which makes it possible to sufficiently prevent the lateral portion 112b from separating outward from the tray 30. Since the lower end 3221d of the wing flange 3221 is bent toward the inner side, the lateral portion 112b of the cell corner portion 112, i.e., the lower end of the lateral portion of the main body of the cell 11 is prevented from coming into contact with the inner portion of the wing flange 3221.

According to the battery carrying tray 30 according to the present disclosure described above, the insert 322 and the insert base 324, which constitute the mounting part 320 for the battery 10, are structured to be assembled, and the respective shape elements related to the contact parts of the battery 10 are controlled. Therefore, basically, the movements of the tab welded portion 14 and the main body of the cell 11 in the accommodated state are minimized, the contact is avoided, the locally applied stress is minimized, or optionally, the direct contact with the cell corner portion 112 is avoided. Therefore, it is possible to effectively prevent the important parts, which directly affect the performance of the battery 10, from being damaged by contact or vibration occurring during the process and reduce a defect of the battery 10.

The above description relates to the specific embodiments of the present disclosure. The embodiments according to the present disclosure have been disclosed above for the purpose of explanation but are not understood as limiting the scope of the present disclosure. It should be understood that various alterations and modifications may be made by those skilled in the art without departing from the subject matter of the present disclosure. All the modifications and alterations may be understood as falling into the scope of the present disclosure disclosed in the claims or the equivalents thereof.

What is claimed is:

1. A battery carrying tray comprising:
a box-shaped outer peripheral frame; and
a pair of slot-shaped mounting parts symmetrically mounted in the outer peripheral frame,
wherein when an inner side of the battery carrying tray is an inner side and an outer side of the battery carrying tray is an outer side, the mounting part comprises:
an insert having a plurality of first slots into which lateral ends of cells of batteries are inserted, and a plurality of second slots into which tab welded portions of the batteries are inserted and supported; and
an insert base having seating portions on which lower ends of the cells of the batteries are seated,
wherein the insert comprises:
a plurality of pins disposed in parallel at predetermined intervals to define the first slots therebetween;
wing flanges respectively formed at outer ends of the pins to define the second slots between the wing flanges formed on the adjacent pins; and
a horizontal base portion on which the plurality of pins is supported, and
wherein upper and lower portions of a lateral end of the wing flange are convex toward an inner space of the second slot, and a middle portion of the wing flange is concave and has a wavy shape as a whole.

2. The battery carrying tray of claim 1, wherein the pin has a convex portion formed toward an inner space of the first slot.

3. The battery carrying tray of claim 2, wherein the convex portion has a gradient that decreases toward the inner side.

4. The battery carrying tray of claim 1, wherein an entrance distance of an outer lateral end of the seating portion to an inner end of the pin of the insert is restricted, an upper surface of the seating portion is positioned higher than an upper surface of the horizontal base portion, and a lower end of the wing flange is bent toward the inner side.

5. The battery carrying tray of claim 4, wherein an inclined portion inclined toward the outer side is provided at an inner lower end of the pin.

6. The battery carrying tray of claim 1, wherein the insert and the insert base are assembled in a snap-fit manner.
